(19) United States
(12) Patent Application Publication
(10) Pub. No.: US 2025/0369770 A1
(43) Pub. Date: Dec. 4, 2025

(54) SYSTEMS AND METHODS FOR ESTIMATING BOUNDARY LINES ON A ROAD BY COMPARING VEHICLE RELATIONSHIPS

(71) Applicant: Toyota Jidosha Kabushiki Kaisha, Toyota-shi Aichi-ken (JP)

(72) Inventor: Alexander Christoph Schaefer, Fremont, CA (US)

(21) Appl. No.: 18/733,056

(22) Filed: Jun. 4, 2024

(51) Int. Cl. G01C 21/00

(52) U.S. Cl. CPC G01C 21/3822

(57) ABSTRACT

Systems, methods, and other embodiments described herein relate to comparing vehicle relationships for inferring lane structure from detected lines and executing vehicle tasks by identifying boundary lines of a road. In one embodiment, a method includes forming lines by connecting keypoints detected from vehicles using sensor data. The method also includes comparing similarity metrics for line pairs from the lines along a longitudinal path, the similarity metrics including associative relationships between the vehicles and the line pairs on a road. The method also includes generating a map with a boundary line for the road identified with the line pairs using scores upon satisfying criteria for the similarity metrics.

### TECHNICAL FIELD

The subject matter described herein relates, in general, to estimating boundary lines for a road, and, more particularly, to comparing vehicle relationships for inferring lane structure with detected lines and executing vehicle tasks.

### BACKGROUND

Vehicles equipped with sensors use sensor data to perceive a surrounding environment and execute vehicle tasks. For example, a vehicle equipped with a camera sensor acquires images about the surrounding environment, while logic associated detects a presence of objects and other features of the surrounding environment. In further examples, additional/alternative sensors such as radar acquire information about the surrounding environment from which a system derives awareness about aspects for the vehicle tasks. This sensor data can be useful in various circumstances for improving perceptions of the surrounding environment so that systems such as automated driving systems (ADS) can accurately plan and navigate a vehicle accordingly.

In various implementations, systems use camera data (e.g., images) to estimate road attributes (e.g., lane lines) and locate objects for a vehicle. These systems can control safety applications and navigate the vehicle with the road attributes and high-definition (HD) maps. For example, details in HD map data improve the accuracy of tasks such as lane tracking by an ADS. HD map data is sometimes unavailable, stale, etc., for a geographic area. Systems generating maps from detected road attributes for updating the HD map data encounter errors within complex areas (e.g., overpasses, curves, intersections, etc.) that demand manual feedback. System costs and delays increase when computing tasks involve manual feedback and verification. Accordingly, systems detecting road attributes encounter deficiencies for safety applications and map generation involving complex scenarios, thereby diminishing the effectiveness of vehicle tasks.

### SUMMARY

In one embodiment, example systems and methods related to comparing vehicle relationships for inferring lane structure from detected lines and executing vehicle tasks by identifying boundary lines of a road are disclosed. In various implementations, systems estimate road layout from sensor data through detecting objects within a driving scene, such as lane lines and road boundaries. However, these systems can be computationally complex and encounter inaccuracies from missing data, sensor errors, etc. Furthermore, the systems sometimes demand manual annotation of detected lane information that is laborious, time-consuming, and expensive. Thus, systems estimating lane information for vehicle tasks encounter diminished reliability from data gaps and elevated costs when demanding manual feedback for verifying estimates.

Therefore, in one embodiment, an estimation system identifies boundary lines on a road automatically and efficiently without manual inputs (e.g., annotation) that improves the reliability of vehicle tasks. Here, the estimation system can form lines from connecting keypoints using sensor data that is local and information received from other vehicles. In one approach, the lines are paired along paths that are common for multiple vehicles and the pairs can estimate lane structure. The estimation system can compare similarity metrics for the line pairs among associative relationships using sizes. For example, a line pair having an increased overlap size (e.g., corresponding x-values, corresponding x and y values, etc.) for right lines from different vehicles indicates that the vehicles are co-occupying a lane. From the associative relationship, the estimation system can execute a vehicle task (e.g., generate a map, automated driving, etc.) automatically using the right line as a boundary line (e.g., a lane line, a road boundary, etc.). Accordingly, the estimation system accurately and automatically identifies boundary lines through comparing similarity metrics and associative relationships of line pairs, thereby improving vehicle tasks factoring boundary lines.

In one embodiment, an estimation system that compares vehicle relationships for inferring lane structure from detected lines and executing vehicle tasks by identifying boundary lines of a road is disclosed. The estimation system includes a memory storing instructions that, when executed by a processor, cause the processor to form lines by connecting keypoints from vehicles using sensor data. The instructions also include instructions to compare similarity metrics for line pairs from the lines along a longitudinal path, the similarity metrics including associative relationships between the vehicles and the line pairs on a road. The instructions also include instructions to generate a map with a boundary line for the road identified with the line pairs using scores upon satisfying criteria for the similarity metrics.

In one embodiment, a non-transitory computer-readable medium for comparing vehicle relationships and inferring lane structure from detected lines and executing vehicle tasks by identifying boundary lines of a road and including instructions that when executed by a processor cause the processor to perform one or more functions is disclosed. The instructions include instructions to form lines by connecting keypoints from vehicles using sensor data. The instructions also include instructions to compare similarity metrics for line pairs from the lines along a longitudinal path, the similarity metrics including associative relationships between the vehicles and the line pairs on a road. The instructions also include instructions to generate a map with a boundary line for the road identified with the line pairs using scores upon satisfying criteria for the similarity metrics.

In one embodiment, a method for comparing vehicle relationships for inferring lane structure from detected lines and executing vehicle tasks by identifying boundary lines of a road is disclosed. In one embodiment, the method includes forming lines by connecting keypoints from vehicles using sensor data. The method also includes comparing similarity metrics for line pairs from the lines along a longitudinal path, the similarity metrics including associative relationships between the vehicles and the line pairs on a road. The method also includes generating a map with a boundary line for the road identified with the line pairs using scores upon satisfying criteria for the similarity metrics.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an estimation system that is associated with comparing vehicle relationships for inferring lane structure with detected lines and executing related tasks.

FIGS. 3A-3D illustrate examples of forming lines and inferring associative relationships among vehicles using line pairs for automatically identifying boundary lines on a road.

FIG. 4 illustrates one example of the vehicle traveling on a road and automatically identifying the boundary lines.

FIG. 5 illustrates one embodiment of a method that is associated with comparing similarity metrics for the line pairs along a path and identifying the boundary lines on a road.

### DETAILED DESCRIPTION

Systems, methods, and other embodiments associated with comparing vehicle relationships from detected lines for inferring lane structure and identifying boundary lines to support vehicle tasks are disclosed herein. In various implementations, systems on a vehicle detect boundary lines on a road using sensor data (e.g., camera data) through recording perceived points for lines, boundaries, etc. For example, lane boundaries are represented by keypoints that are to the left and right of the vehicle along a trace (e.g., a trajectory). A keypoint can be a salient point derived from sensor data (e.g., an image, video, etc.) that matches features within a scene (e.g., a driving environment). The systems detecting and generating boundary lines from keypoints encounter errors, particularly when combining estimates from various vehicles. For instance, a system identifies a left line as a lane boundary when the left line is actually associated with an adjacent lane. This driving scenario can occur when the vehicle is traveling right of center from the lane and lines go undetected from perceptions using the sensor data. A cause can be that the line is beyond a field-of-view (FoV) of vehicle sensors (e.g., a camera, an infrared sensor, etc.). As such, systems using keypoint data for detecting boundary lines on a road encounter driving scenarios that cause identification errors and confusion, thereby reducing reliability and confidence for vehicle tasks.

Therefore, in one embodiment, an estimation system tests different associative relationships for vehicles occupying a lane and lines detected by the vehicles for comparing overlapping sizes and identifying boundary lines. In particular, the estimation system can compare similarity metrics for line pairs detected using keypoints detected by the vehicles traveling along a similar path. For example, the estimation system computes overlapping detections along coordinate axes and combinations of the line pairs perceived by the vehicles through grouping, thereby simplifying computations and reducing iterative processing. Here, a line pair can be formed with lines from multiple vehicles that overlap along the similar paths (e.g., longitudinal paths). The line pair can be identified with a vehicle source, a lane position (e.g., left lane, right lane, left adjacent lane, etc.) and an instance for deriving lane structure. Furthermore, the computation can include estimating a size that the line pair overlaps with intersecting values (e.g., 500 meters), a lateral gap between corresponding points of the line pair, etc. Scoring results from overlap computations can indicate relative positions of vehicles (e.g., co-occupying a lane, lane offsets, relative alignment, etc.). For instance, the estimation system selects line pairs as a boundary line when the score is elevated for a line size within a particular geographic area. However, line pairs from an elevated lateral gap may be disregarded as indicating vehicles traveling in different lanes and disjoint lane boundaries. In this way, the estimation system compares and scores associative relationships for line pairs that improve reliability associated with identifying boundary lines on a road.

Moreover, in one embodiment, the estimation system utilizes comparison results that satisfy criteria to generate a map with boundary lines (e.g., a lane line, a road boundary, etc.) identified with the line pairs. Here, the criteria can represent meeting an associative relationship, a minimum score, etc. For instance, an associative relationship assumes that multiple vehicles are occupying the same lane and computes an overlap between left and right lines within a line pair. However, the overlap gap between corresponding points of the line pair is greater than a threshold (e.g., a few meters) for traveling within the same lane. As such, the estimation system outputs that the associative relationship is unlikely and the vehicles are likely traveling in different lanes. For additional accuracy, the estimation system fails at identifying other associative relationships across the line pairs compared by the vehicle associated with satisfying the criteria. Accordingly, the estimation system robustly and automatically locates boundary lines while reducing computational complexity and costs, thereby improving vehicle tasks relying upon road layouts.

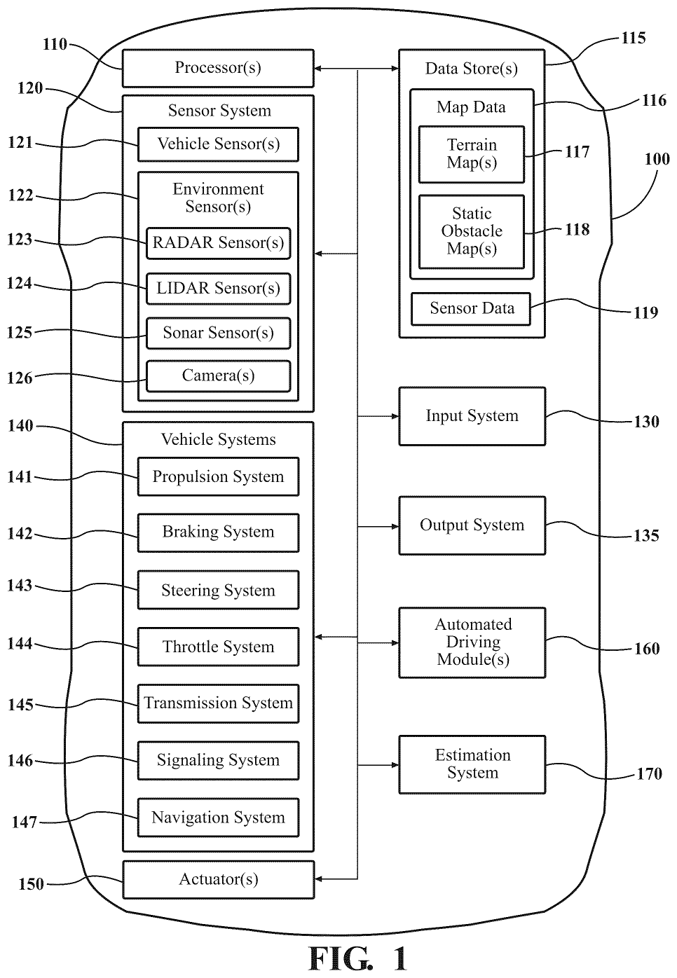

Referring to FIG. 1, an example of a vehicle 100 is illustrated. As used herein, a “vehicle” is any form of motorized transport. In one or more implementations, the vehicle 100 is an automobile (e.g., an ego vehicle, an ado vehicle, etc.). While arrangements will be described herein with respect to automobiles, it will be understood that embodiments are not limited to automobiles. In some implementations, an estimation system 170 uses road-side units (RSU), consumer electronics (CE), mobile devices, robots, drones, and so on that benefit from the functionality discussed herein associated with comparing vehicle relationships from detected lines for inferring lane structure and identifying boundary lines on a road to support vehicle tasks.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

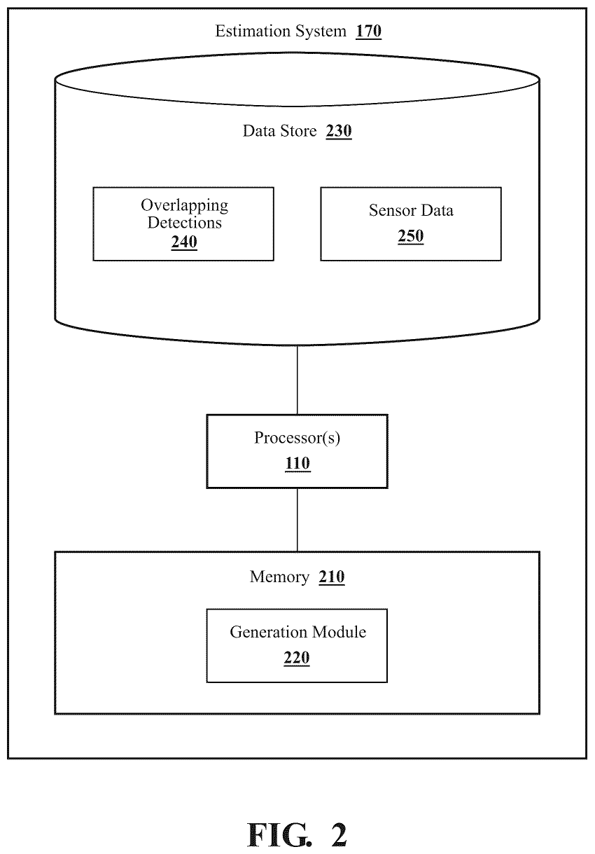

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to comparing vehicle relationships from detected lines for inferring lane structure and identifying boundary lines to support vehicle tasks. Furthermore, the estimation system 170, in various embodiments, is implemented partially within the vehicle 100, and as a server task, a cloud-based service, etc.

With reference to FIG. 2, one embodiment of the estimation system 170 of FIG. 1 is further illustrated. The estimation system 170 is shown as including a processor(s) 110 from the vehicle 100 of FIG. 1. Accordingly, the processor(s) 110 may be a part of the estimation system 170, the estimation system 170 may include a separate processor from the processor(s) 110 of the vehicle 100, or the estimation system 170 may access the processor(s) 110 through a data bus or another communication path. In one embodiment, the estimation system 170 includes a memory 210 that stores the generation module 220. The memory 210 is a random-access memory (RAM), a read-only memory (ROM), a hard-disk drive, a flash memory, or other suitable memory for storing the generation module 220. The generation module 220 is, for example, computer-readable instructions that when executed by the processor(s) 110 cause the processor(s) 110 to perform the various functions disclosed herein.

Moreover, the estimation system 170 as illustrated in FIG. 2 is generally an abstracted form of the estimation system 170. The estimation system 170 and/or generation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the estimation system 170, in one embodiment, acquires sensor data 250 that includes at least camera images, radar data, infrared information, etc., such as from sensor system 120. In further arrangements, the estimation system 170 acquires the sensor data 250 from further sensors such as radar sensors 123, LIDAR sensors 124, and other sensors as may be suitable for identifying vehicles and locations of the vehicles.

Accordingly, the estimation system 170, in one embodiment, controls the respective sensors to provide the data inputs in the form of the sensor data 250. Additionally, while the estimation system 170 is discussed as controlling the various sensors to provide the sensor data 250, in one or more embodiments, the estimation system 170 can employ other techniques to acquire the sensor data 250 that are either active or passive. For example, the estimation system 170 passively sniffs the sensor data 250 from a stream of electronic information provided by the various sensors to further components within the vehicle 100. Moreover, the estimation system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. In one embodiment, the estimation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the generation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the overlapping detections 240 that represent data points (e.g., keypoints) that overlap for detected lines that are grouped into line pairs. An overlap can be lines detected from keypoints having values that partially, completely, minimally, etc., intersect. An overlap can also be lines detected by different vehicles running along a coordinate axis (e.g., x-axis) that do not have intersecting values.

Furthermore, the overlapping detections 240 include a corresponding size (e.g., absolute, relative, etc.) of the overlap. For instance, the overlapping detections 240 include lines and corresponding sizes representing keypoints that intersect (e.g., 200 meters). In another example, the overlapping detections 240 is an area or a lateral gap measured by a difference between corresponding points of line pairs having keypoints that intersect (e.g., at a point, a line segment, etc.) or run parallel without intersecting keypoints. As explained below, the overlapping detections 240 can also be a probabilistic estimate for the line pairs computed with a model (e.g., a learning model).

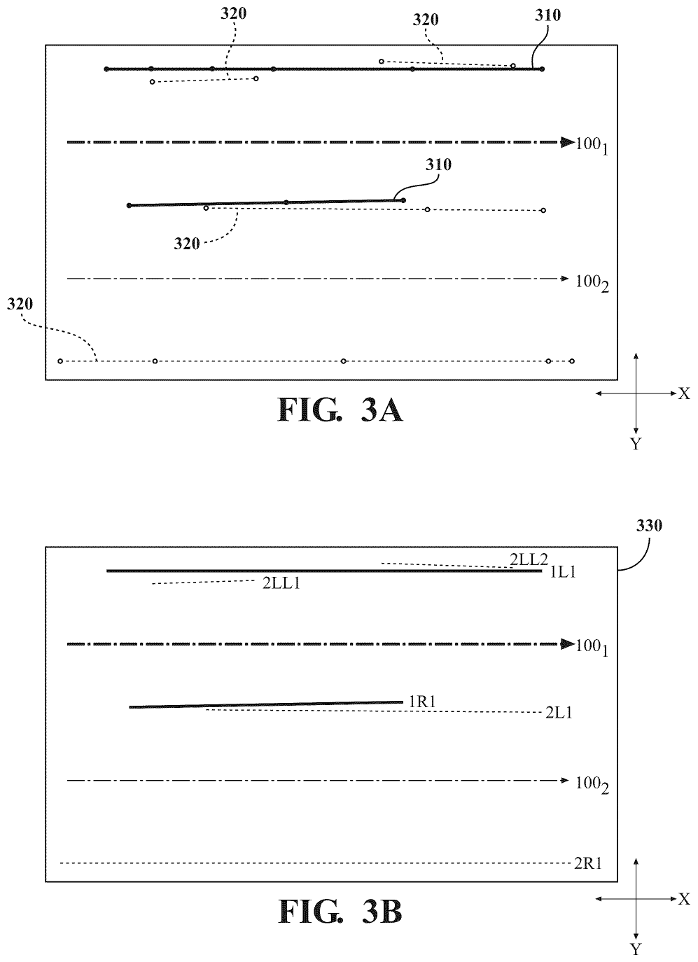

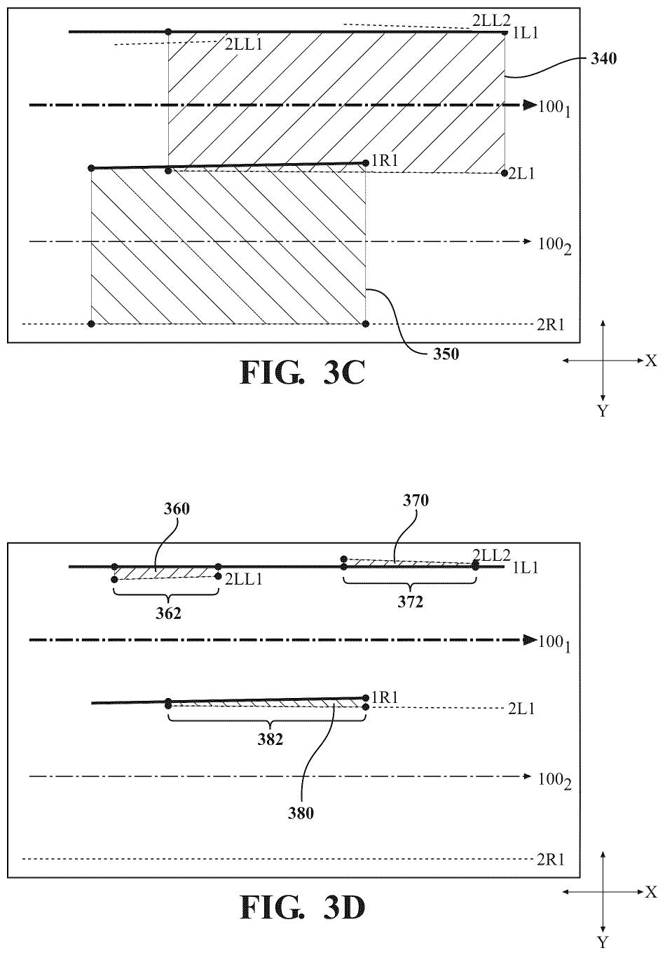

Regarding FIGS. 3A-3D, examples of forming lines and inferring associative relationships among vehicles using line pairs for automatically identifying boundary lines on a road are illustrated. In various implementations, the estimation system 170 and/or generation module 220 includes instructions that cause the processor 110 to form lines by connecting keypoints detected from vehicles using sensor data. The estimation system can compare similarity metrics for line pairs from the lines along lateral and longitudinal geometries (e.g., polygon, line, triangle, etc.), the similarity metrics including associative relationships between the vehicles and the line pairs on a road. Furthermore, upon satisfying similarity metrics for criteria, the generation module 220 generates a map with boundary lines for the road identified with the line pairs. As explained below, the estimation system 170 can identify the line pairs using scores. In one approach, the vehicle 100 executes tasks (e.g., lane keeping, lane tracking, etc.) using boundary lines selected by the estimation system 170 rather than map generation, thereby saving computation costs while improving performance.

Turning to details about forming lines, FIG. 3A illustrates keypoints detected by different vehicles 100₁ and 100₂. In the examples given herein, the lines and boundary lines are identified online, offline, or any combination thereof. Furthermore, the vehicle 100, a server, remote server, a cloud server, etc., can independently or partly form the lines and identify the boundary lines. For example, the server reduces computing load for the vehicle 100 associated with detecting boundary lines and updating maps using the estimation system 170. In another example, the vehicle 100₁ acquires and merges fleet data from the server that includes line detections about a road for predicting boundary lines and generating maps, accordingly. In FIG. 3A, the keypoints 310 are generated by the vehicle 100₁, while keypoints 320 are generated by 100₂. A keypoint can be a relevant point derived from the sensor data (e.g., an image, video, etc.) that matches features within a scene (e.g., a driving environment). In one approach, the keypoints 310 are detected using the sensor data 250 acquired from a safety system, such as Toyota Safety Sense (TSS). Additionally, the vehicle 100₁ follows a sporadic line (e.g., dotted, dashed, etc.) that is a trace representing a current path, trajectory, etc., for currently traveling along the road. Similarly, the vehicle 100₂ follows another sporadic line (e.g., dotted, dashed, etc.) that is a trace representing a current path, trajectory, etc. In one approach, the vehicle 100₂ detects lines by connecting keypoints and perceiving an adjacent lane where the vehicle 100₁ is currently traveling through acquiring data from a FoV. As such, the vehicle 100₂ has diverse and robust information about boundary lines while traveling along the road.

In FIG. 3A, the vehicle 100₁ can form lines about the current lane while receiving information about other lanes directly from the vehicle 100₂, through a server, etc., for identifying boundary lines. In another approach, the vehicle 100₁ can form lines about multiple lanes on road to compare with lines formed by the vehicle 100₂ traveling nearby. This information can be acquired by the vehicle 100₁ directly from the vehicle 100₂, remotely through a server, etc. Thus, the vehicle 100₁ can leverage a multiplicity of sources about lines detected with keypoints for identifying boundary lines and executing related tasks.

As illustrated in FIG. 3A, the estimation system 170 connects keypoints detected from the sensor data 250 by the vehicle 100₁ and forms lines accordingly. In one approach, forming a line involves ordering the keypoints along a vehicle trace and connecting consecutive keypoints relative to the trace and a line pair. Here, a line pair can represent grouped lines formed by multiple vehicles that overlap along longitudinal paths. In one embodiment, an overlap are lines detected from keypoints having values that partially, completely, minimally, etc., intersect. An overlap can also be lines detected by different vehicles running along a coordinate axis (e.g., x-axis) that do not have intersecting values, such as when measuring a lateral gap. As such, a gap can be a lateral distance between line pairs. Furthermore, alignment can measure a similarity between a line pair, such as an area between overlapping areas of a line pair for measuring a lane offset as explained below.

A comparison of the line pair and inferring associative relationships between vehicles may indicate lane structure for a road. For added accuracy, in one approach, the estimation system 170 uses a machine learning (ML) algorithm, such as a convolutional neural network (CNN), to perform semantic segmentation over the sensor data 250 and identify lines. Of course, in further aspects, the estimation system 170 may employ different ML algorithms or implement different approaches for performing the associated functions, which can include deep convolutional encoder-decoder architectures, or another suitable approach that generates semantic labels for the separate object classes represented in the image. Whichever particular approach the estimation system 170 implements an output can include semantic labels identifying objects represented in the sensor data 250. In this way, the estimation system 170 can increase accuracy by comparing line existence and size predicted with the ML algorithm with that formed through connecting the keypoints.

Now discussing FIG. 3B, the keypoints 310 and 320 and formed lines having labels is illustrated. Here, a label can identify a line estimated for a keypoint(s) with the following: a vehicle identification (ID); a right detection or a left detection indicator relative to a trace (e.g., a trajectory) including lines within an adjacent lane; and a detection instance (e.g., an integer, an alphanumeric value, etc.). For example, FIG. 3B includes the following labels upon road 330:
1L1—first immediate left line detected by the vehicle 100₁;
1R1—first immediate right line detected by the vehicle 100₁;
2L1—first immediate left line detected by the vehicle 100₂;
2R1—first immediate right line detected by the vehicle 100₂;
2LL1—first further left line detected by the vehicle 100₂ (e.g., adjacent lane); and
2LL2—second further left boundary detected by the vehicle 100₂ (e.g., adjacent lane).

Accurately detecting boundary lines can encounter difficulties using detected lines from the sensor data 250. For example, the estimation system 170 infers that 1L1, 2LL2, and 2LL1 represent either the same or different boundary lines without complex processing. Otherwise, the estimation system 170 comparing differences between the distance of traces about the vehicles 100₁ and 100₂ rather than using associative relationships and line overlaps can encounter errors (e.g., false negatives, false positives, etc.). Furthermore, the estimation system 170 iterates over various similarity metrics for line pairs among any one of the lines 1L1, 1R1, 2L1, 2R1, 2LL2, and 2LL1 for understanding a relationship between the vehicle 100₁ and the vehicle 100₂ and improving accuracy. A similarity metric can involve testing an assumption that vehicles are co-occupying a lane, traveling about different lanes, etc. For instance, 1L1 and 2L1 represent the same boundary if the vehicle 100₁ and the vehicle 100₂ are both traveling in the same lane. However, the vehicle 100₂ is traveling along the lane to the right of the vehicle 100₁ in FIG. 3C, thereby making the inferred relationship less probable than other assumptions. As such, in one approach, the estimation system 170 clusters the lines based on a lateral gap and distance for inferring associations geometrically and iterates across possible assumptions. Still, certain lane structures may require further estimations that avoid merging boundary lines of narrow lanes, such as concurrently associating across formed lines detected from different perceptions.

For further verification, the estimation system 170 can test additional assumptions iteratively between the vehicle 100₁ and the vehicle 100₂ and compares scores (e.g., overlaps) across possible relationships and hypotheses for identifying the most probable relationship. For example, the estimation system 170 initially assumes that the vehicle 100₁ and the vehicle 100₂ are traveling along the same lane in FIG. 3C. In one approach, the estimation system 170 computes an overlap area between corresponding lines and detected keypoints under the assumption that the vehicle 100₁ and the vehicle 100₂ are in the same lane. Here, the overlap area between lines 1L1 and 2L1 represented by area 340 and the overlap between lines 1R1 and 2R1 represented by area 350 are computed. In this case, the area 340 and the area 350 have overlaps along an x-axis of an x-y coordinate system although the corresponding lines lack an intersection point. In this example, the line pairs 1L1, 2L1, 1R1, and 2R1 are labeled with instance identifiers and the line pairs indicate estimated structure for one of a current lane and an adjacent lane. The estimation system 170 infers that the vehicle 100₁ and the vehicle 100₂ are unlikely co-occupying a lane and traveling in different lanes upon the area 340 and the area 350 between two different line pairs having an elevated level. On the contrary, the gap between corresponding line pairs is minimal, diminished, etc., when the vehicle 100₁ and the vehicle 100₂ are traveling in the same lane.

In view of the elevated area between corresponding line pairs, in FIG. 3D the estimation system 170 executes another iteration with an assumption that the vehicle 100₂ is traveling in the lane immediately right of the lane that the vehicle 100₁ is traveling. Here, the estimation system 170 computes the overlaps between lines 1L1 and 2LL1 as overlap 360, 1L1 and 2LL2 as overlap 370, and 1R1 and 2L1 as overlap 380. The overlaps may be gaps between corresponding keypoints among stretches 362, 372, and 382 for a particular instance captured using sensor data. A comparison indicates the overlaps 360-380 are less than the area 340 and the area 350. As such, the assumption is correct since the overlaps are minimal and the estimation system 170 associates lines 1L1, 2LL1, and 2LL2 with the same lane boundary (e.g., topmost lane boundary). The estimation system 170 also associates 1R1 and 2L1 with the same lane boundary (e.g., middle lane boundary).

Moreover, associative relationships between vehicles can include co-occupying a lane and traveling in different lanes using sizes of the line pairs. As additional confirmation, the estimation system 170 can compute that the sizes for stretches 362, 372, and 382 are beyond a minimum threshold (e.g., 100 m). Similar to area comparisons, the estimation system 170 associates lines 1L1, 2LL1, and 2LL2 with the same lane boundary and 1R1 and 2L1 with the same lane boundary (e.g., middle lane boundary) since the minimum threshold for size is satisfied. Furthermore, the generation module 220 can subsequently generate a map, update an existing map, etc., with the lane boundary identified by comparing areas, line sizes, etc., of line pairs. In one approach, the vehicle 100 forgoes map generation and updates a task (e.g., automated driving) using boundary lines selected by the estimation system 170, thereby saving computational resources associated with map generation.

In various implementations, the estimation system 170 matches lines with measurements other than overlapping areas. For example, the estimation system 170 calculates that an overlapping distance along a longitudinal trace between detected lines of the vehicle 100₁ and the vehicle 100₂ is z meters (e.g., 200 m) for 1R1 and 2L1, respectively. Although 2L1 is longer than 1R1 (e.g., 20 m), the estimation system 170 infers that they represent the same boundary line and generates a map accordingly. As added confidence, the estimation system selects the line pairs by comparing a score being elevated for the line size and diminished for one of the area, the lateral gap, and the probabilistic estimate for 1R1 and 2L1. In this way, the reliability of identifying boundary lines using associative relationships is increased for the vehicle 100 with data confluence.

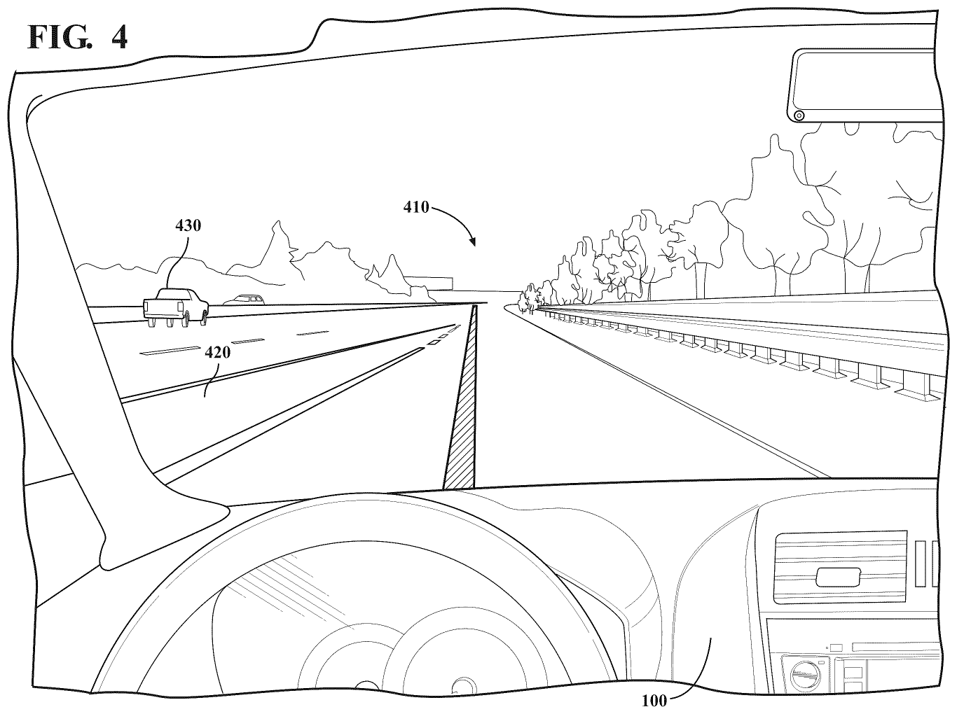

Concerning FIG. 4, one example of the vehicle 100 traveling on a road and automatically identifying boundary lines is illustrated. Here, the vehicle 100 encounters a driving scenario 410 of merging onto a road having a median 420 and a pickup truck 430. In one approach, the estimation system 170 computes iteratively for different overlaps of the line pairs associated with the vehicle 100 and the pickup truck 430 associated with detecting a boundary line of the median 420. Here, the different overlaps can be one of a line size (e.g., longitudinally), an area between the line pairs, a lateral gap between the line pairs, etc. As previously explained, the estimation system 170 can test various relational assumptions involving the vehicle 100 and the pickup truck 430 co-occupying a lane using the different overlaps. This can include combining relational assumptions and predicting lane offsets, lateral offsets, relative alignment, etc., between the vehicle 100 and the pickup truck 430 using detected boundary lines. For instance, the vehicle 100 and the pickup truck 430 are traveling in different lanes from an overlap of the line pairs being elevated for a first one of the associative relationships (e.g., overlapping line size). Regarding offsets, differences between positional values of traces for the vehicle 100 and the pickup truck 430 to a road boundary identified with the line pairs indicate a lateral offset. Another associative relationship indicates a diminished value (e.g., overlap area) between the vehicle 100 and the pickup truck 430. Accordingly, the estimation system 170 infers that the vehicle 100 and the pickup truck 430 are occupying different lanes and selects the line pairs as a boundary line (e.g., a lane boundary, a road boundary, etc.).

Besides heuristic approaches (e.g., trial and error) involving the relational assumption, in one embodiment, the estimation system 170 can compute a probabilistic estimate for the line pairs. For instance, the most probable associative relationship between traces for the vehicle 100 and the pickup truck 430 is one that minimizes the sum of the squared errors between the actual keypoints and averaged lines for a positional relationship. As such, the estimation system 170 computes overlaps across possible line pairs until satisfying the probabilistic estimate and selects a line pair as a boundary line, accordingly.

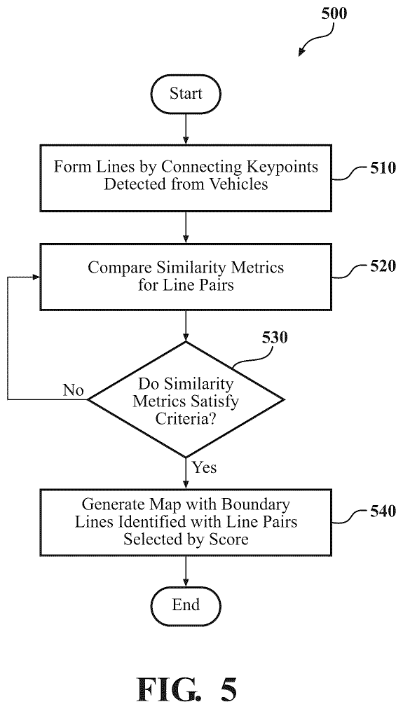

Now discussing FIG. 5, a flowchart of a method 500 that is associated with comparing similarity metrics for the line pairs and identifying the boundary lines. Method 500 will be discussed from the perspective of the estimation system 170 of FIGS. 1 and 2. While the method 500 is discussed in combination with the estimation system 170, it should be appreciated that the method 500 is not limited to being implemented within the estimation system 170 but is instead one example of a system that may implement the method 500. In various implementations, the vehicle 100 observes keypoints from an adjacent lane along with those from a current lane. Keypoints for the current lane can also go undetected according to vehicle position while being detectable from the adjacent lane. As explained below, the method 500 can recognize boundary lines and lanes from keypoint detections through iterating across possible associative relationships between different vehicles and lanes (e.g., traces) and identify relevant line pairs for various traces through scoring. In this way, the method 500 reconciles detected lines among the current lane and the adjacent lane for accurately identifying boundary lines, thereby improving system confidence and reliability.

At 510, the estimation system 170 forms lines by connecting keypoints detected from vehicles. Here, the lines and boundary lines may be identified online, offline, etc., on the vehicle 100 and/or a server. The lines can be lane boundaries, road boundaries, medians, road edges, etc. In one approach, the keypoints are generated by different vehicles traveling on a road and the keypoints are relative to a trace that represents a current path, trajectory, etc. As previously explained, sensor FOVs for the vehicles allow capturing the sensor data 250 for adjacent lanes and the estimation system 170 form lines with keypoints detected from the sensor data 250, accordingly. In this way, the estimation system 170 can form lines for roads having complex lane structures and geometries through having an expanded FOV.

Moreover, in various implementations, forming the lines involves ordering the keypoints along a vehicle trace and connecting consecutive keypoints. For the formation, the estimation system 170 can implement an ML algorithm to perform semantic segmentation over formed lines for identifying lines. Furthermore, the vehicle 100 can form lines about multiple lanes on the road and compare the lines with those formed by other vehicles nearby. This information can be acquired by the vehicle 100 directly from the other vehicles, through a server, etc. Similarly, the vehicle 100 can form lines about the current lane while receiving information about other lanes from the other vehicles, through a server, etc., for identifying boundary lines.

At 520, the estimation system 170 compares similarity metrics for line pairs from the lines. Here, a similarity metric can involve a heuristic approach that iteratively tests overlapping areas, overlapping lengths, etc., between line pairs comprising the formed lines. In one approach, the similarity metric involves modeling a probability for line pairs formed that are overlapping longitudinally and fitting various vehicle associations. For example, the estimation system 170 tests a vehicle association that is a relationship representing two or more vehicles co-occupying the same lane through comparing the formed lines. Furthermore, a line pair can include grouped lines formed with keypoints from multiple vehicles where the line pair may overlap along longitudinal paths and the estimation system 170 can identify lane structure through inferring associative relationships between the vehicle 100 and other vehicles.

In one approach, comparing the similarity metrics indicates that overlaps along an x-axis of an x-y coordinate system have corresponding line pairs are greater or less than a value. For example, instances of two right lines detected with the vehicle 100 and another vehicle are paired and exhibit corresponding keypoints that differ. Here, the difference involves an area associated with a gap that increases from 10 m to 20 m laterally along traces within a lane computed by the vehicle 100 and the another vehicle. However, instances of multiple left lines detected by the vehicle 100 and another vehicle have corresponding keypoints that differ and decrease from 10 m to 5 m along the traces. As such, the estimation system 170 can assume that the multiple left lines are for the same lane boundary (e.g., topmost lane boundary) since the area is minimal and the vehicles co-occupy a lane. As added confirmation, the estimation system 170 tests another similarity metric about lane occupancy among the vehicle 100 and other vehicles traveling in different lanes. As previously explained, the estimation system 170 can also compare both lateral and longitudinal overlaps between line pairs. For instance, the left lines longitudinally overlap along 150 m for an instance. In this way, the estimation system 170 improves reliability for identifying boundary lines with data confluence.

Regarding another comparison of overlapping lengths, the estimation system 170 can calculate an overlapping distance longitudinally between detected lines of the vehicle 100 and other vehicles for disjoint line pairs. This can involve an overlap having x and y values of keypoints from different vehicles crossing for line pairs. For example, a right line and a left line detected by different vehicles are disjoint. Computing a similarity metric with the right line and left line with the assumption that the different vehicles occupy adjacent lanes can identify whether the lines belong to a same boundary line. Here, the estimation system 170 can establish that the lines are candidates for representing the same boundary line although an overlap and intersecting points may be limited compared with the overlap length of the lines. As previously explained, verifying the boundary line can involve testing other assumptions about vehicle lane associations, satisfying criteria, and meeting scoring parameters.

At 530, the estimation system 170 determines whether the similarity metrics for the line pairs satisfy criteria. In one approach, satisfying the criteria involves similarity metrics meeting a minimum for a relational determination after Z iterations. Another criteria can be at least two similarity metrics verifying associative relationships between the vehicles and the line pairs on a road for the vehicle 100 (e.g., co-occupying a lane, driving on an empty lane, etc.) Furthermore, satisfying the criteria can involve the similarity metric verifying a positional relationship for the vehicle 100 and a minimum score for line pairs. A score may be any one of an absolute value, a maximum value, a probability score, etc., associated with comparing line pairs. Furthermore, the estimation system 170 iterates across possible associative relationships between different vehicles and lanes (e.g., traces) and scores line pairs accordingly.

At 540, upon satisfying the criteria, the generation module 220 generates a map with boundary lines identified with the line pairs selected using scores. Here, a score can indicate a difference of a gap between beginning keypoints, ending keypoints, etc., associated with a line pair for an instance, multiple instances, etc. The score can also be different from comparing consecutive keypoints among a line pair longitudinally. Furthermore, an ML model can output the probabilistic score by minimizing squared errors between the actual keypoints and averaged lines for a positional relationship associated with the similarity metric. If a similarity metric does not satisfy criteria, the estimation system 170 can continue comparing similarity metrics by testing other assumptions involving associative relationships between the vehicles across remaining line pairs.

Regarding selecting the line pair, the maximum value of different scores outputted from tests involving various similarity metrics can indicate candidates for boundary lines through comparing trace relationships and co-occupancy relationships. As added confidence, the estimation system 170 selects the line pairs by comparing a score being elevated for a line size and diminished for one of the area, the lateral gap, and the probabilistic score associated with the line pair. Upon selecting boundary lines by score, the estimation system 170 can generate a new map for an area surrounding the vehicle 100. An existing map can also be updated as needed with the selected boundary lines when the existing map has gone stale, such as due to construction, land development, etc.

In one approach, automated driving module 160 of the vehicle 100 updates tasks (e.g., lane keeping, lane tracking, etc.) using boundary lines selected by the estimation system 170, thereby saving computation costs associated with map generation. Furthermore, the estimation system 170 can predict lane offsets, lateral offsets, relative alignment, etc., between the vehicle 100 and other vehicles using detected boundary lines through geometric computations relative to traces. For example, differences between positional values of traces for different vehicles to a boundary line identified with the line pairs indicate a lateral offset. Thus, the estimation system 170 automatically and reliably identifies boundary lines associated with a road layout through associative relationships and line geometries that reduce computational complexity, thereby improving tasks relying upon accurate lane information.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the estimation system 170, and/or the automated driving module(s) 160 can be operatively connected to communicate with the various vehicle systems 140 and/or individual components thereof. For example, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
form lines by connecting keypoints detected from vehicles using sensor data;
compare similarity metrics for line pairs from the lines along a longitudinal path, the similarity metrics including associative relationships between the vehicles and the line pairs on a road; and
upon satisfying criteria for the similarity metrics, generate a map with a boundary line for the road identified with the line pairs using scores.

2. The estimation system of claim 1, wherein the instructions to compare the similarity metrics further include instructions to:
compute different overlaps of the line pairs associated with a first vehicle and a second vehicle from the vehicles, wherein the different overlaps are one of a line size, an area between the line pairs, a lateral gap between the line pairs, and a probabilistic estimate for the line pairs; and
estimate that a first vehicle and a second vehicle are co-occupying a lane using the different overlaps.

3. The estimation system of claim 2 further including instructions to:
select the line pairs according to one of the scores being elevated for the line size and diminished for one of the area, the lateral gap, and the probabilistic estimate; and
predict a lateral offset between the first vehicle and the second vehicle within the lane using the different overlaps.

4. The estimation system of claim 3 further including instructions to:
predict the probabilistic estimate by a model that minimizes squared errors between the keypoints and average values for the lines.

5. The estimation system of claim 1 further including instructions to:
predict that a first vehicle and a second vehicle are traveling in different lanes from a first overlap being elevated and a second overlap being diminished for the line pairs using different ones of the associative relationships.

6. The estimation system of claim 1, wherein the instructions to form the lines further include instructions to:
order the keypoints along a trajectory as a trace for one of the vehicles; and
connect consecutive keypoints relative to the trace and one of the line pairs.

7. The estimation system of claim 1, wherein the associative relationships include one of the vehicles co-occupying a lane and traveling in different lanes according to sizes of the line pairs.

8. The estimation system of claim 1, wherein the line pairs include labels with instance identifiers and the line pairs indicate estimated structure for one of a current lane and an adjacent lane.

9. The estimation system of claim 1, wherein the criteria include meeting one of the associative relationships and a minimum for the scores.

10. A non-transitory computer-readable medium comprising:
instructions that when executed by a processor cause the processor to:
form lines by connecting keypoints detected from vehicles using sensor data;
compare similarity metrics for line pairs from the lines along a longitudinal path, the similarity metrics including associative relationships between the vehicles and the line pairs on a road; and
upon satisfying criteria for the similarity metrics, generate a map with a boundary line for the road identified with the line pairs using scores.

11. The non-transitory computer-readable medium of claim 10, wherein the instructions to compare the similarity metrics further include instructions to:
compute different overlaps of the line pairs associated with a first vehicle and a second vehicle from the vehicles, wherein the different overlaps are one of a line size, an area between the line pairs, a lateral gap between the line pairs, and a probabilistic estimate for the line pairs; and
estimate that a first vehicle and a second vehicle are co-occupying a lane using the different overlaps.

12. A method comprising:
forming lines by connecting keypoints detected from vehicles using sensor data;
comparing similarity metrics for line pairs from the lines along a longitudinal path, the similarity metrics including associative relationships between the vehicles and the line pairs on a road; and
upon satisfying criteria for the similarity metrics, generating a map with a boundary line for the road identified with the line pairs using scores.

13. The method of claim 12, wherein comparing the similarity metrics further includes:
computing different overlaps of the line pairs associated with a first vehicle and a second vehicle from the vehicles, wherein the different overlaps are one of a line size, an area between the line pairs, a lateral gap between the line pairs, and a probabilistic estimate for the line pairs; and
estimating that a first vehicle and a second vehicle are co-occupying a lane using the different overlaps.

14. The method of claim 13 further comprising:
selecting the line pairs according to one of the scores being elevated for the line size and diminished for one of the area, the lateral gap, and the probabilistic estimate; and
predicting a lateral offset between the first vehicle and the second vehicle within the lane using the different overlaps.

15. The method of claim 14 further comprising:
predicting the probabilistic estimate by a model that minimizes squared errors between the keypoints and average values for the lines.

16. The method of claim 12 further comprising:
predicting that a first vehicle and a second vehicle are traveling in different lanes from a first overlap being elevated and a second overlap being diminished for the line pairs using different ones of the associative relationships.

17. The method of claim 12, wherein forming the lines further includes:
ordering the keypoints along a trajectory as a trace for one of the vehicles; and
connecting consecutive keypoints relative to the trace and one of the line pairs.

18. The method of claim 12, wherein the associative relationships include one of the vehicles co-occupying a lane and traveling in different lanes according to sizes of the line pairs.

19. The method of claim 12, wherein the line pairs include labels with instance identifiers and the line pairs indicate estimated structure for one of a current lane and an adjacent lane.

20. The method of claim 12, wherein the criteria include meeting one of the associative relationships and a minimum for the scores.
